(19) United States
(12) Patent Application Publication
(10) Pub. No.: US 2022/0095815 A1
(43) Pub. Date: Mar. 31, 2022

(54) WATCH STAND

(71) Applicant: Andre G. Lavoie, Littleton, CO (US)

(72) Inventor: Andre G. Lavoie, Littleton, CO (US)

(21) Appl. No.: 17/426,696

(22) PCT Filed: Oct. 23, 2020
(86) PCT No.: PCT/US2020/056964

§ 371 Date: Jul. 29, 2021

Related U.S. Application Data
(63) Continuation of application No. 16/663,863, filed on Oct. 25, 2019, now abandoned.

(51) Int. Cl. A47F 7/02

(52) U.S. Cl. CPC A47F 7/022; G02B 25/002

(57) ABSTRACT

A watch stand configured to receive a smart watch including a face. The watch stand includes a receptacle configured to temporarily receive the smart watch within it with the smart watch positioned on edge and a body configured to magnify the face of the smart watch when the smart watch is viewed through the body.

### BACKGROUND OF INVENTION

### 1. Field of Invention

This invention relates generally to apparatus, systems and methods to convert a watch to a table clock. More specifically, at least one embodiment, relates to apparatus, systems and methods for temporarily converting a smartwatch to a table clock.

### 2. Discussion of Related Art

Smartwatches, for example, watches that share some of the same functionality as smart phones have greatly increased in popularity during the past decade. The Apple Watch demonstrates the rapid adoption of smartwatches by consumers as the capabilities of the watch are increased. For example, today's smartwatches offer internet connectivity, text messaging, voice control, fitness tracking and health monitoring among other functionality.

Like today's smartphone's, today's smartwatches are powered by integral rechargeable batteries that typically require charging on a daily basis. Generally a user will remove the smartwatch when they arrive home or before going to bed and allow it to charge overnight. Often the watch is located on a night stand or other piece of furniture within line of sight of the user. Currently, there are two general types of smartwatch chargers: charging docks and charging cords. The charging cords offer a compact size, lower cost and portability. However, charging cords place the smartwatch face-up rather than in an on-edge orientation. As a result, the user must stand above the charger to view the face of the phone which is located on its back on top of the charger. This does not allow the watch face to be viewed from various locations within line of sight of the charger. In contrast, some charging docks allow a smartwatch to stand on edge when connected to the charger. In addition, the watch can be placed on its side for viewing on a bedside table provided the wristband supports the weight of the watch. However, none of the preceding approaches provide any magnification of the watch face regardless of orientation. The preceding is problematic because the watch face is inherently limited in size which makes the watch face difficult to see or to touch to take advantage of its accelerometer-functions. Current approaches also make it difficult to hear audio projected from the watch making it difficult to take advantage of the limited audio capacity of the watch. While the preceding are not shortcomings with the watch worn by the user, the limited size of both the watch-face and the display-area limit the utility of the watch once it is removed from the wrist. In addition, the utility of the watch is further limited when removed from the user's wrist by the limited audio capacity of the watch.

Antique glass ball clocks were manufactured using the movement and face of a pocket watch sealed within a glass ball. Typically, the movement is wound using a stem that extends from the top of the clock. While the watch elements are those of a pocket watch, the overall circular shape provides a magnifying effect to the watch that allows the device to be set on a flat surface and employed as a clock. However, this device does not allow the watch to be removed from the glass ball or employed as a wrist watch. Because of their overall size and shape, the glass ball clocks limit the utility of the device only to that as a table clock.

### SUMMARY OF INVENTION

Therefore, there is a need for apparatus, systems and methods that allow a user to temporarily convert a smart wristwatch to a table clock. According to various embodiments, a smartwatch is placed within a watch stand that includes a spherical face. These embodiments can also include a charging device in the watch stand. These embodiments can activate the smart watch such that the display is on while it is located within the watch stand while providing a magnification of the watch face when viewed through the front of the watch stand.

According to one aspect, a watch stand includes a base that defines a bottom surface; a body coupled to the base, the body includes a curved front surface and a back surface angled vertically in a rearward direction at a first angle. The watch stand also includes a rear projection having a front side and a back side, the rear side coupled to the base and extending upward from the base at a second angle, and a gap defined in a region located between the back surface of the body and the front side of the rear projection. In some embodiments, the gap is sized to receive a watch. In further embodiments, a face of the watch is magnified relative to actual size when viewed through the curved front surface with the watch received within the gap.

According to another aspect a watch stand is configured to receive a smart wrist watch including a face. The watch stand includes a receptacle configured to temporarily receive the smart watch within it with the smart watch positioned on edge; and a body configured to magnify the face of the smart watch when the smart watch is viewed through the body when received within the receptacle. According to a further embodiment, the receptacle is formed as a slot accessible from the top of an overall spherical or hemispherical shaped body.

According to a further aspect, a method of converting a smart watch to a table clock with a watch stand having a viewing-side is provided. According to some embodiments, the method includes providing the watch stand with a magnifying front face on the viewing side and a receptacle located behind the magnifying front face, locating a charging device for the smart watch within the watch stand, and placing the smart watch within the receptacle. In further embodiments, the receptacle is configured to receive the smart watch with the watch-face oriented in a direction of the magnifying front face where the location is selected to automatically initiate a charging of a battery included in the smart watch when the smart watch is received within the receptacle. According to further embodiments, the method includes providing the receptacle as a slot located within a body having an overall spherical shape or hemispherical shape depending on the embodiment.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 illustrates a front view of a watch stand with an adjacent watch in accordance with one embodiment;

FIG. 2 illustrates a front view of the watch stand of FIG. 1 with the watch located within the watch stand according to one embodiment;

FIG. 3 illustrates a top exploded view of the watch stand of FIG. 1 with the watch adjacent the watch stand according to one embodiment;

FIG. 4 illustrates a side view of the watch stand of FIG. 1 according to one embodiment;

FIG. 5 illustrates a side view of the watch stand of FIG. 1 with the watch located within the watch stand according to one embodiment;

FIG. 6 illustrates a cross sectional view of the watch stand of FIG. 1 according to one embodiment;

FIG. 7 illustrates a side exploded view of the watch stand of FIG. 1 with the watch adjacent to the watch stand according to one embodiment;

FIG. 8 illustrates a rear view of the watch stand of FIG. 1 in accordance with one embodiment;

FIG. 9 illustrates a bottom view of the watch stand of FIG. 1 with the watch located within the watch stand according to one embodiment;

FIG. 10 illustrates a bottom perspective view of the watch stand of FIG. 1 in accordance with one embodiment;

FIG. 11 illustrates another embodiment of a watch stand;

FIG. 12 illustrates a magnified view of a region of the watch stand illustrated in FIG. 11; and

FIG. 13 illustrates a cross sectional view of the watch stand of FIG. 11 according to one embodiment.

### DETAILED DESCRIPTION

This invention is not limited in its application to the details of construction and the arrangement of components set forth in the following description or illustrated in the drawings. The invention is capable of other embodiments and of being practiced or of being carried out in various ways. Also, the phraseology and terminology used herein is for the purpose of description and should not be regarded as limiting. The use of “including,” “comprising,” or “having,” “containing”, “involving”, and variations thereof herein, is meant to encompass the items listed thereafter and equivalents thereof as well as additional items.

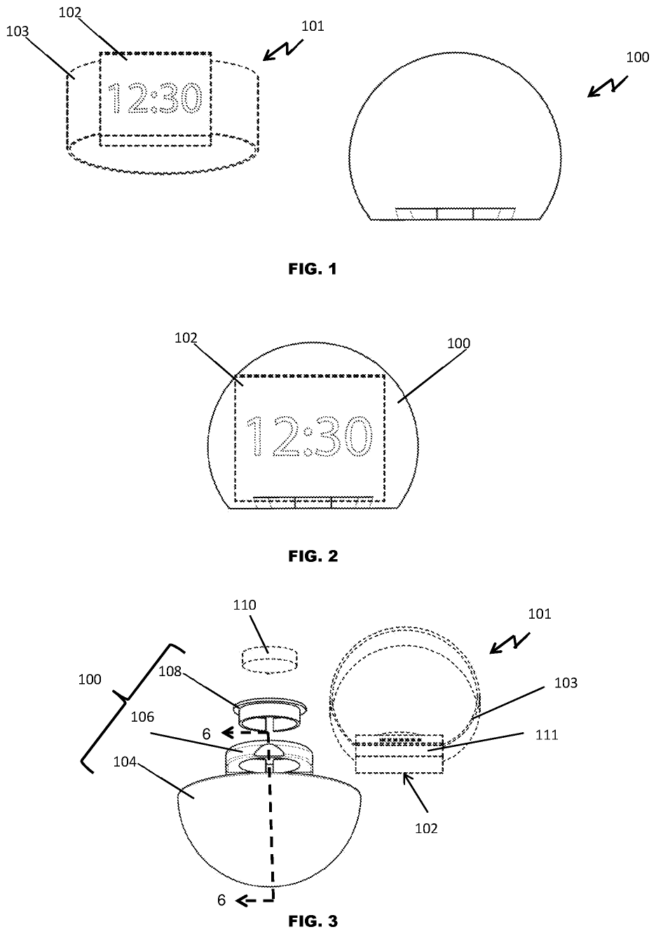

Referring now to FIG. 1, a front view of a watch stand 100 is illustrated with a watch 101, illustrated in phantom, located adjacent to the watch stand 100. As illustrated in FIG. 1, the watch 101 includes a face 102 and a watch band 103. FIG. 2 illustrates the watch 101 located within the watch stand 100 with the watch placed on its side or edge. In particular, the watch 101 is placed on a side that does not include an attachment for the watch band 103. As a result, the watch band 103 extends out opposite sides of the watch stand 100.

According to the illustrated embodiment, the face 102 is magnified when viewed through the front of the watch stand 100. According to the illustrated embodiment, the information displayed in the watch face is magnified at least two times (2×) actual size. As a result, the watch stand 100 enables a user to temporarily place the watch 101 in the watch stand 100 to create a table clock. As described herein, the watch stand 100 can also include a charging device to allow the watch 101 to be charged while it is also employed as a table clock.

Depending on the embodiment, a curvature provided on the side of the watch stand 100 through which the face 102 is viewed can provide a wide variety of magnification. That is, the amount of magnification can be provided as an integer or non-integer multiples of X based on convex shape of the watch stand 100. The magnification can be selected based on a minimum size of the face to be readable or a desired size of the information displayed. In general, the magnification is controlled by the convexity of the watch stand, in particular, the selected convexity of a body included in the watch stand.

Referring now to FIG. 3, a top exploded view of the watch stand 100 is illustrated with the watch 101, illustrated in phantom, located adjacent to the watch stand 100. As seen in FIG. 3, the watch stand 100 includes a body 104, a rear projection 106 and a washer 108. A charging device 110 is also illustrated in phantom. The watch 101 includes the watch band 103 and a body of the watch 111 where the face 102 is located at a front side of the body 111.

According to the illustrated embodiment, the washer 108 is received within an opening located on the backside of the rear projection 106. The washer 108 includes a generally circular overall shape including a circular central opening within the washer itself. The central opening is sized and shaped to receive the charging device 110. Accordingly, the size and shape of the central opening can vary based on the size and shape of the charging device 110 depending on the embodiment. In some embodiments, the washer 108 can be manufactured from rubber or another resilient material that provides a higher friction surface.

According to various embodiments, the charging device 110 is a wireless charger, for example, an inductive charging device. The charging device 110 can include charging devices that include magnets or magnetic material to assist in aligning the charging device 110 and the watch 101 for inductive charging. According to various embodiments, the watch stand 100 includes alignment features that act to automatically align the watch 101 with the charging device 110 when the watch 101 is received within the watch stand 100.

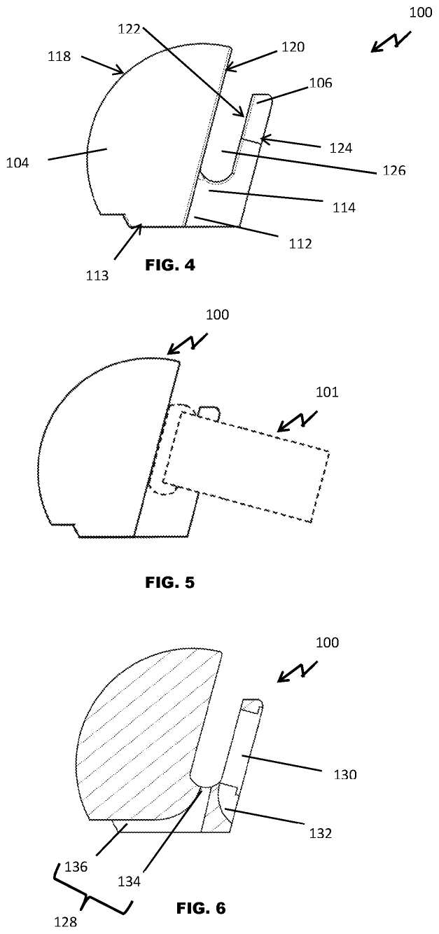

Referring now to FIG. 4, a side view of the watch stand 100 is illustrated according to one embodiment. The body 104 and the rear projection 106 are located on a base 112. The watch stand 100 includes a central region 114. According to the illustrated embodiment, the body 104 and the rear projection 106 are coupled to one another via the central region 114. The base 112 provides a surface 113 that defines an overall level plane. As a result, the base 112 allows the watch stand 100 to be placed on a flat surface and remain stable. According to one embodiment, an underside of the base 112 includes a non-slip surface, for example, a non-slip coating applied to the underside of the base 112.

In the illustrated embodiment, the body 104 includes a curved front surface 118 that provides the body 104 with an overall hemispherical shape. The body also includes a rear surface 120. According to the illustrated embodiment, the rear surface 120 is flat and formed at a rearward angle. That is, the rear surface 120 is located at an acute angle when measured as the angle between the rear surface 120 and the surface 113.

The rear projection 106 includes a front face 122 and a rear face 124. According to the illustrated embodiment, each of the front face 122 and the rear face 124 define an overall planar face that is angled rearward. Further, in the illustrated embodiment, the angle of each of the front face 122 and the rear face 124, respectively, are the same acute angle when measured relative to the surface 113. In the illustrated embodiment, the rearward angle of the front face 122 of the rear projection and the rear face 124 are the same as the rearward angle of the rear surface 120 of the body 104. The rear projection 106 has a constant overall thickness as a result.

A gap 126 (or “slot”) is defined as a region located between the rear surface 120 of the body 104 and the front face 122 of the rear projection 106. This gap 126 in combination with additional features of the watch stand 100 provides a receptacle within which the watch 101 is received. Features included in the rear projection 106 assist in automatically laterally-centering the face 102 of the watch within the watch stand 100. Further, the depth of the gap 126 is established at least in part by the height of the central region 114 and the length of the rear projection 106. According to some embodiments, the depth of the gap is established such that the dial and button that control aspects of the watch are both located at the top of the watch when it is received within the watch stand 100. The preceding orientation conveniently places these controls right behind the top of the body 104 within reach of a user when they choose to access the controls. According to further embodiments, the size and shape of the gap 126 are selected to accommodate multiple sizes of watches, and in some embodiments, watches from various manufacturers. In still another embodiment, the interior dimensions of the gap 126 can be modified with a clear pad or other insert that allows the watch stand 101 to accommodate multiple different watches. Further, some of the preceding embodiments provide for the use of different device chargers that can be placed in the same location in the rear projection 106 depending on the make and model of the watch.

Depending on the embodiment, the watch stand 100 can be produced in acrylic or another plastic, glass, crystal or lead crystal. According to some embodiments, the watch stand 100 is manufactured using a single piece of material. According to these embodiments, the watch stand 100 is an integral solid piece of material including the various features illustrated and described herein depending on the embodiment.

Depending on the embodiment, either or both of the curved front surface 118 and the rear surface 120 can be coated to improve the performance of the watch stand 100. In one embodiment, the curved front surface 118 is coated with an anti-reflective coating. In another embodiment, the rear surface 120 is coated with an anti-scratch coating to prevent the surface 120 from being scratched by the watch 101 or other objects that might be placed in the gap 126. The preceding embodiments can be employed together, for example, the curved front surface 118 can be coated with an anti-reflective coating and the rear surface 120 is coated with the anti-scratch coating. Further, the curved front surface 118 can be coated with each of the anti-reflective coating and the anti-scratch coating.

In some embodiments, the watch stand 100 is clear to provide a completely transparent body 104 through which the face 102 of the watch is viewed in a magnified state. Further, emblems, logos, icons or other graphic art can be included in the body 104. According to these embodiments, the graphic elements are formed within the body 104 or laser engraved in the body or on a surface thereof during manufacture of the watch stand 100. For example, the watch stand 100 can include features that illustrate Jupiter, the Deathstar, or a unicorn floating inside of the body 104. These features become prominent when illuminated by the face 102 of the watch 101 with the watch received in the gap 126. Further, these graphic elements are also magnified when viewed through the body 104 as a result of the curved front surface 118. As a result, these graphic elements (whether etched or otherwise provided on or within the body 104) are highlighted when the watch 101 is projecting light. According to one embodiment, the watch stand 100 is manufactured with a color tint or other feature that provide a translucent body 104.

In addition to the magnification of content displayed in the face 102 of the watch 101, the watch stand 100 also magnifies any illumination provided by the watch. That is, light is transmitted from the display include in the watch and magnified to increase the ambient illumination projected from the watch stand 100. According to some embodiments, the watch 101 is set within the watch stand 100 to display colored content on the face 102 to provide a desired color of ambient light.

FIG. 5 illustrates a side view of the watch 101 received within the watch stand 101. According to the illustrated embodiment, the receptacle is sized and shaped such that the watch 101 is centered within the watch stand 100 with the face 102 of the watch facing in the forward direction where it can be viewed through the curved front surface 118 of the body 104. Further, the angles of the front face 122 of the rear projection and the rear surface 120 of the body 104 orient the watch 101 such that the face 102 is angled slightly upward. The preceding feature can allow a standing-user to more easily see the content displayed on the watch 101 as magnified.

Smart watches generally included speakers that allow them to broadcast sound to the user. The speakers are located along a region of an edge of the watch body 111. According to various embodiments, the watch stand 100 includes a sound channel to accommodate the clear projection of audio from the watch 101 when received within the watch stand. The preceding facilitates a number of use-cases to assist the user, for example, phone calls, receiving notifications that include audio and streaming music to name a few. According to further embodiments, the watch stand 100 also facilitates the receipt of audio inputs via a microphone included in the watch. According to these embodiments, the sound channel facilitates the use of a digital assistant such as Siri because the watch 101 is able to detect audio spoken by the user and project audible replies.

Referring now to FIG. 6, a cross sectional view of the watch stand 100 is illustrated in accordance with one embodiment. The watch stand 100 includes a sound channel 128, an opening 130 and a slot 132. The sound channel 128 includes a proximate end 134 and a distal end 136. The proximate end 134 is located in the central region 114 at the base of the gap 126. The distal end 136 is located at the front of the base 112. That is, the sound channel 128 exits at the front of the watch stand 100. According to various embodiments, the receptacle formed by the rear face 120, the front face 122 and the gap is sized and shaped to orient the watch 101 in a single orientation that directs the face 102 toward the body 104 and centers the body 111 of the watch 101 laterally within the gap 126.

In this orientation, the edge of the body 111 that includes the speaker(s) is located on the downward facing edge of the watch 101. The speakers are aligned with and facing the proximate end 134 of the sound channel in this orientation. Thus, even with the watch stand 100 located on a solid surface, sound projected by the speaker(s) is clearly transmitted to the user via the sound channel 128. According to further embodiments, the sound channel is sized and shaped to amplify sound transmitted by the speaker(s) included in the watch.

In some embodiments, the opening 130 is sized and shaped to receive the washer 108 and have the charging device 110 be located within the washer 108. According to these embodiments, an outer circumference of the opening 130 includes a recessed region configured to receive a rim of the washer while maintaining the washer flush with the rear surface 124 of the rear projection 106. In other embodiments, the charging device 110 is received directly within the opening 130 and a washer is not used. The charging devices generally include a power cord. The slot 132 is sized and shaped to receive the power cord included in the charging device 110. According to the illustrated embodiment, the slot 132 sweeps radially outward from the opening 130. According to this embodiment, the slot 132 gradually bends a cord inserted within it such that it exits the watch stand 100 extending in a near horizontal orientation. That is, the sweep of the power cord provided by the slot bends the cord away from the surface on which the watch stand 100 is placed. The preceding assists in maintaining the watch stand in an upright and stable position when the watch stand is placed on a flat surface with the device charger 110 installed.

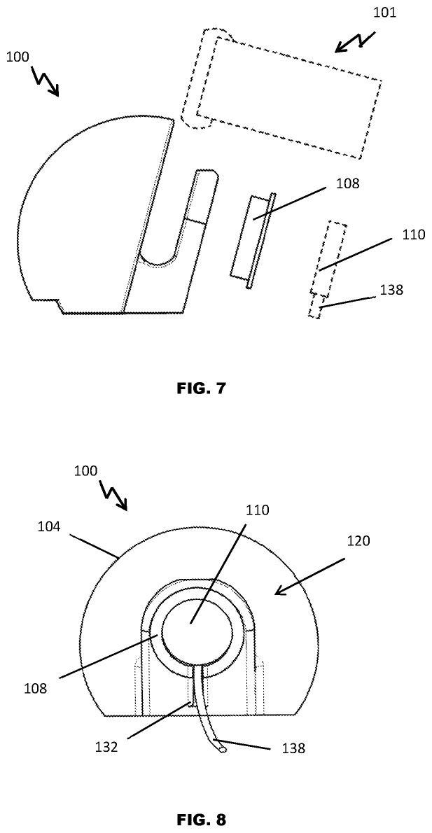

FIG. 7 illustrates a side exploded view of the watch stand 100, the watch 101, the washer 108 and the device charger 110. In FIG. 7, each of the watch 101 and the device charger 110 are illustrated in phantom. FIG. 7 also illustrates a portion of the power cable 138 included in the device charger 110. FIG. 8 illustrates a rear view of the watch stand 100 with the washer 108 and device charger 110 located in place in the stand. The power cord 138 extends from the rear projection 106 via the slot 132. In various embodiments, the washer 108 is a material that will not mar the material of construction of the rear projection, for example, the washer 108 can be manufactured from rubber or another resilient material that provides a softer, higher friction surface relative to each of the material of the rear projection 106 and material of the device charger 110. The size and shape of the washer 108 is also selected to provide a secure fit of the charging device 110 within the washer 108.

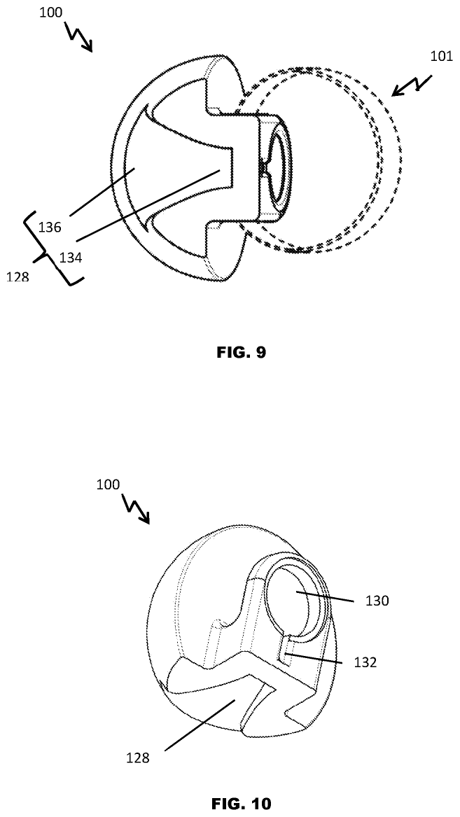

Referring now to FIG. 9 a bottom view of the watch stand 100 is illustrated. According to the illustrated embodiment, the bottom of the sound channel 128 is open from the proximate end 134 to the distal end 136 of the channel 128. This embodiment can be employed to increase the cross-sectional area of the sound channel 128 by eliminating a solid bottom in that region. Instead, in this embodiment, the sound channel 128 is formed by three walls formed within the base 112 and any surface that the watch stand 100 is placed upon. In practice, the sound channel 128 in combination with the surface on which the watch stand 100 is placed creates a sound chamber that projects sound in a forward direction relative to the watch stand 100.

A sound channel 128 as illustrated in FIG. 9 also reduces the complexity and cost of any mold and associated manufacturing process employed to manufacture the watch stand 100. FIG. 10 illustrates a bottom perspective view of the watch stand 100. FIG. 10 highlights the sound channel 128, the opening 130 and the slot 132.

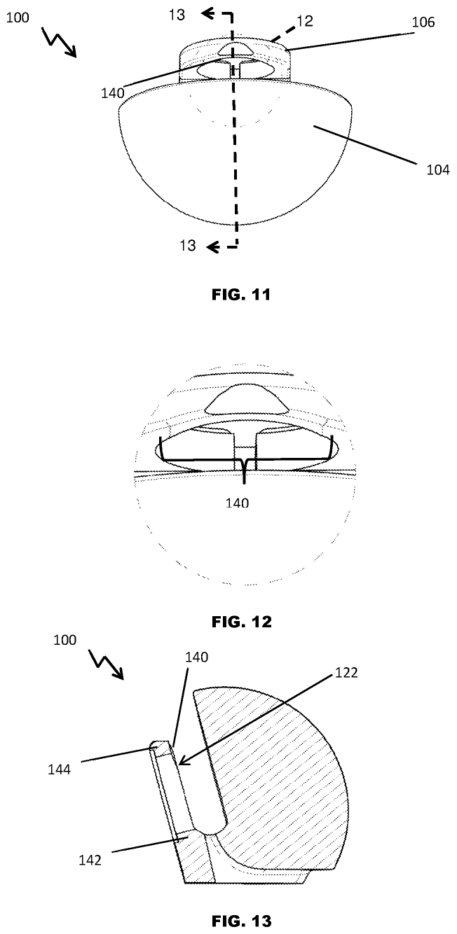

As described above, embodiments provide a receptacle that automatically laterally aligns the body 111 of the watch 101 to centrally align the face 102 within the watch stand 100. Referring now to FIGS. 11-13, another embodiment of a watch stand 200 is illustrated including a base 212 and a rear projection 206 including a recessed region 240. The rear projection 206 includes a front surface 222, a proximate end 242 and a distal end 244. The proximate end is located where the rear projection 206 joins the base 212. The recessed region 240 is formed in the front surface 222 at the distal end 244 of the rear projection 206. According to the illustrated embodiment, the recessed region 240 is formed by adding a slight bow in the front surface at the top of the projection 206. The recessed region 240 guides the watch to the center of the gap 226 when the watch is placed in the watch stand 200. In addition, the recessed region 240 prevents any lateral movement that will otherwise misalign the face of the watch once it is received within the gap 226. Other modifications in the shape of the front surface 122, 222 can be provided depending on the embodiment provided that they are configured to accommodate the body 111 to center a selected watch or watches within the watch stand 100, 200.

Inertial measurement sensors, such as accelerometers, included in smart watches allow the watch to sense and respond to movement and impacts. These systems are generally employed only when the watch is being worn by the user. For example, a user wearing a smart watch can tap the watch to activate the display or take a desired action. Embodiments described herein allow a user to operate the watch 101 in a similar fashion when the watch is received within the watch stand 100. As one example, when the display is off with the watch 101 located in the watch stand 100, the user can simply tap the body 104 to have the watch-display activate in response. In various embodiments, the much larger surface area of the body 104 relative to the watch body 111 itself makes it much easier for the user to activate the display. This feature can also be employed to respond to an operation of the watch, for example, to turn off an alarm or other notification provided by the watch.

According to other embodiments, the touch screen features of the watch 100 can be directly employed via the body 104. For example, the body 104 of the watch stand 100 can be manufactured from a conductive material that allows the user's touch-actions on the curved front surface 118 to be sensed by the touch-screen display included in the face 102 of the watch. As one example, the user can swipe up/down on the curved front surface 118 to transmit this action to the face 102. According to these embodiments, the thickness of the gap 126 and alignment features included in either of the rear surface 120 of the body and the front surface 122 of the rear projection maintain the face 102 in contact with the rear surface 120 when the watch 101 is received in the watch stand 100.

Decorative accessories can also be included in the watch stand 100, 200. For example, a band can loop around the body 104, 204 to add a desired aesthetic feature to the watch stand 100, 200. The band can be a metal or colored plastic selected to match or otherwise complement the housing of the watch 102.

As described above, the shape of the body 104, 204 of the watch stand 100, 200 provides an optical effect (i.e., magnification). According to other embodiments, the body 104, 204 can include a discrete optical element to provide magnification. According to these embodiments, alternate shapes can be employed while still magnifying the face 102 of the watch 101 when viewed through the front of the body 104, 204. For example, the face (or surface) of the body 104, 204 can include an optical element such as an optical metasurface or a Fresnel lens that allow the shape of the front face to be flat or substantially flattened and the mass of the body reduced. According to some embodiments, the front of the body 104, 204 is a planar surface. According to various embodiments, a thin flat front surface of the body 100, 200 facilitates the use of the touch screen included in the face 102 of the watch 101 with the watch located in the stand. That is, the touch screen features of the watch 100 can be directly employed via the body 104, 204 by allowing the user's touch-actions on a flat front surface to be sensed by the touch-screen display included in the face 102 of the watch. According to various embodiments, a flat front surface of the body 104, 204 allows the touch locations on the front surface to be more easily mapped to or aligned with the corresponding locations on the face 102 of the watch 104.

While shown and described with reference to a smart watch, embodiments of the watch stands 100, 200 can be employed with a conventional watches that include any of an analog face, a digital-numeric face or a graphical face. Further, embodiments can be employed with battery-operated watches and watches that require hand winding.

Having thus described several aspects of at least one embodiment of this invention, it is to be appreciated that various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

1. A watch stand, comprising:
a base that defines a bottom surface;
a body having a substantially hemispherical shape coupled to the base, the body including a curved front surface and a back surface angled vertically in a rearward direction at a first angle; and
a rear projection coupled to the base and extending upward from the base at a second angle, the rear projection having a front side and a back side;
a gap defined in a region located between the back surface of the body and the front side of the rear projection,
wherein the gap is sized to receive a watch, and
wherein a face of the watch is magnified relative to actual size when viewed through the body with the watch received within the gap.

2. The watch stand of claim 1, wherein the body is transparent.

3. The watch stand of claim 1, wherein the body is translucent.

4. The watch stand of claim 1, wherein the rear projection defines an opening configured to receive a charging device employed to charge the watch when the watch is located in the watch stand.

5. The watch stand of claim 4, further comprising a washer including an external diameter sized and configured to allow the washer to be received within the opening and an internal diameter sized and configured to receive the charging device.

6. The watch stand of claim 4, wherein the opening includes a circular opening located in the rear projection, and wherein the watch stand further comprises a slot located in the rear projection, the slot extending radially outward from the circular opening, the slot sized and configured to receive a power cord.

7. The watch stand of claim 1, wherein the base includes a sound channel configured to project sound from audio speakers included in the watch when the watch is located in the watch stand.

8. The watch stand of claim 7, wherein the sound channel includes a first end located in a region of the base that couples the body to the rear projection and a second end located in a region of the base beneath the curved front surface.

9. The watch stand of claim 8, wherein the first end includes a first cross-sectional area,
wherein the second end includes a second cross-sectional area, and
wherein the second cross-sectional area is greater than the first cross-sectional area.

10.-19. (canceled)
